(19) United States
(12) Patent Application Publication
(10) Pub. No.: US 2003/0182347 A1
(43) Pub. Date: Sep. 25, 2003

(54) Mutiple-platform virtual microprocessor architecture and its corresponding operating system, in particular for onboard and mobile computer field

(76) Inventor: Patrick Dehlinger, L'Union (FR)

Correspondence Address: NIXON & VANDERHYE, PC, 1100 N GLEBE ROAD, 8TH FLOOR, ARLINGTON, VA, 22201-4714, US

(21) Appl. No.: 10/380,837

(22) PCT Filed: Sep. 18, 2001
(86) PCT No.: PCT/FR01/02891

(30) Foreign Application Priority Data
Sep. 20, 2000 (FR) 00/11995

(51) Int. Cl. G06F 17/00

(52) U.S. Cl. 709/1

(57) ABSTRACT

The architecture comprises a host machine itself comprising a hardware platform (110) with a physical host microprocessor, a software platform (120) with a host operating system (121), and memory and hardware manager modules (123 and 124). The host machine is combined with middleware means (130) themselves comprising: a kernel (131) implementing low level functions and including an interface (132) with the host operating system and the memory and hardware managers; an API (134, 135) suitable for receiving executable instructions (200) formulated in a language that is independent of the host microprocessor and system; high level functional modules (133); and means (136, 137) for transcribing the executable instruction code into low level code directly executable on the host microprocessor. All data exchanged between the middleware means (130) and the software platform (120) is implemented via the interface (132). All of the middleware means, with the exception of the interface of the kernel, is encoded in a language that is independent of the host machine.

The invention relates to a novel architecture for a virtual microprocessor.

The term “virtual microprocessor” or “virtual machine” is used to mean a computer configuration that appears from the outside to be an independent machine, but that in fact includes and integrates a host machine (also referred to as a “host platform”) relative to which the virtual machine is a superset.

The host machine itself comprises a hardware platform and a software platform.

The hardware platform comprises a physical microprocessor (the “host microprocessor”) together with its peripherals such as memory, display means, and data input means.

The software platform or “host system” is built around some particular known operating system that drives the host microprocessor directly.

The virtual machine operates in response to instructions of a program written in a language which is specific thereto, and different from the language specific to the host machine.

As explained below, the architecture of the virtual microprocessor of the invention is particularly well adapted to a host hardware environment having computer resources that are small (in terms of memory, clock speed, and lack of mass storage), as occurs with pocket computers of the “palmtop computer” or personal digital assistant (PDA) type, or indeed with cell phones that include data processing functions (WAP, GPRS, etc.), with external decoders for TVs (of the “set-top box” type) or with decoders integrated in TVs, and in general with various mass-market and/or pocket computer electronic goods that integrate functions that are implemented by computer means.

Such goods are commonly referred to by the generic term “mobile and embedded computing” which constitutes the preferred field of application for the invention.

The field of mobile and embedded computing is confronted with a multiplicity of different and incompatible operating systems, and also with a wide variety of hardware platforms.

Amongst the various existing platforms or operating systems, mention can thus be made of the following: EPOC from the Symbian consortium; Windows CE and Windows NT for embedded from Microsoft; PalmOS from Palm Computing; BeOS from BeInc; QNX from IBM; and various “proprietary” operating systems (OS) specific to various manufacturers such as Casio, Texas Instruments, Sharp, etc. (with the various names mentioned being trademarks registered by their respective proprietors).

This multiplicity of platforms goes against present market requirements for mobile and embedded computing, which market is guided by needs for uniformity, simplicity, and cost reduction.

Furthermore, the portability of applications from one platform to another is also a permanent need for applications developers seeking to minimize the amount of work required for adapting any particular applications software on going from one platform to another.

For this purpose, the invention proposes a novel virtual machine architecture that is particularly adapted to mobile and embedded computing, and including “middleware” that operates in symbiosis with and in parallel with the host operating system of the machine.

Essentially, the architecture of the invention relies on a virtual processor and a quasi-operating system that may comprise a database engine, a file manager, a basic input/output operating system (BIOS), and managers for communications, display, and a keyboard, and possibly also a TCP/IP protocol. The virtual microprocessor is incorporated between the main host operating system and the BIOS of the host machine, operating in symbiosis with them and requiring very little memory capacity.

As explained below, the virtual machine is designed in such a manner as to be multiple-platform, i.e. as to require only a minimum amount of modification in order to pass from one host operating system to another.

This multiple-platform nature makes it possible to guarantee the following:

long life for developed applications regardless of changes in hardware and software;

integrity of the host hardware and software platform, the middleware portion of the invention being complementary thereto but not taking its place; as a result applications software operating on the virtual machine of the invention cannot disturb the host operating system, thus making it possible to keep the roles of each of these elements clearly separate;

opening the way to the latest technological innovations for proprietary operating systems by incorporating middleware suitable for imparting the architecture of the invention to the equipment as a whole. Thus, a virtual machine of the invention implanted in a telephone whose operating system is closed enables all of the applications developed on other platforms for the virtual machine of the invention to be operated, for example it enables the telephone to be provided with the latest features developed on other telephones that are more recent; and

finally and above all, by using appropriate development tools, the architecture of the invention makes it possible to accelerate the development cycles of new products very significantly by facilitating applications design and by porting applications from one platform to another.

Software systems already exist that enable communication to take place between platforms, such as Java (trademark filed by Sun Microsystems) or WAP. Nevertheless, those systems differ from the proposal of the invention, and indeed they can be used in addition to the invention. Unlike software written in Java, for example, the virtual machine of the invention constitutes a virtual computer having its own memory stack and its own database, as described below, and it therefore has additional functions available to it. In addition and above all, the virtual computer of the invention can, like a real computer, be programmed in various different languages, unlike Java (or similar products) which is inseparably tied to the structure of the Java virtual machine.

Concerning the resources needed to operate the virtual machine of the invention, the required minimum resources are less than 64 kilobytes (KB) of read-only memory (ROM) and 20 Kb of random-access memory (RAM), and the virtual machine can be implemented using 8-byte processors with clock speeds of less than 3 megahertz (MHz).

These values are entirely compatible with those encountered in mobile and embedded computing, for example in mobile telephones, in contrast to conventional portable or office microcomputers where it can be necessary, for example, to have at least 400 megabytes (MB) of hard disk memory and at least 32 MB of RAM in order to be able to run an operating system such as Windows NT, and even then performance will be very poor in terms of speed.

More precisely, the present invention provides a multiple-platform virtual microprocessor and its corresponding operating system, comprising in combination:

a host machine with: a hardware platform comprising a physical host microprocessor; and a software platform comprising: a host operating system; memory and hardware manager modules; and optional native applications; and

middleware means comprising:

a kernel implementing low level functions, said kernel including an interface with i) said host operating system, ii) said memory and hardware manager modules, and iii) said native applications, if any;

an API suitable for receiving executable instructions formulated in a language that is independent of the host microprocessor and system, the virtual microprocessor operating in response to said executable instructions;

high level functional modules interfaced i) between one another, ii) with the API, and iii) with the kernel; and

means for transcribing the code of said executable instructions into low level code directly executable on the host microprocessor.

All exchange of data between the middleware means and the software platform takes place via said interface of the kernel, and all of the middleware means, excepting said interface of the kernel, is encoded in a language independent of the host machine.

According to various advantageous subsidiary characteristics:

the middleware is incorporated in a read-only memory or in a microcontroller flash memory;

said means for transcribing the executable instruction code into low level code that is directly executable on the host microprocessor comprise a code translator, a just-in-time compiler, and/or a bytecode converter;

said low level functions implemented by the kernel comprise: an IOCS/BIOS; a memory manager distinct from the memory manager of the host platform; and/or a manager for the stacks of the middleware means; optionally together with management of an integrated graphics user interface independent of the host operating system and/or the following functions: allocating and deallocating a memory zone shared between a plurality of applications; an inter-thread semaphore; creating and deleting threads; creating and deleting timers; read after write (RAW) type writing and reading to a video driver; managing a hardware or software keyboard input peripheral; managing a pointer peripheral; managing an output peripheral for a hardware connection; saving energy; and/or giving access to a mass storage system;

said high level functional modules are modules suitable for implementing functions of: managing a file system; a database engine; communicating with the outside; a TCP/IP stack; managing a printer; reading an electronic book; a hypertext module; managing a graphics interface and a graphics module; tools and a library of auxiliary functions; and/or an interface for making a call to a local system; and

the middleware means are means suitable for being implemented in supervisor mode of the operating system.

There follows a description of an embodiment with reference to the sole accompanying FIGURE which is a block diagram showing the architecture of the virtual machine of the invention.

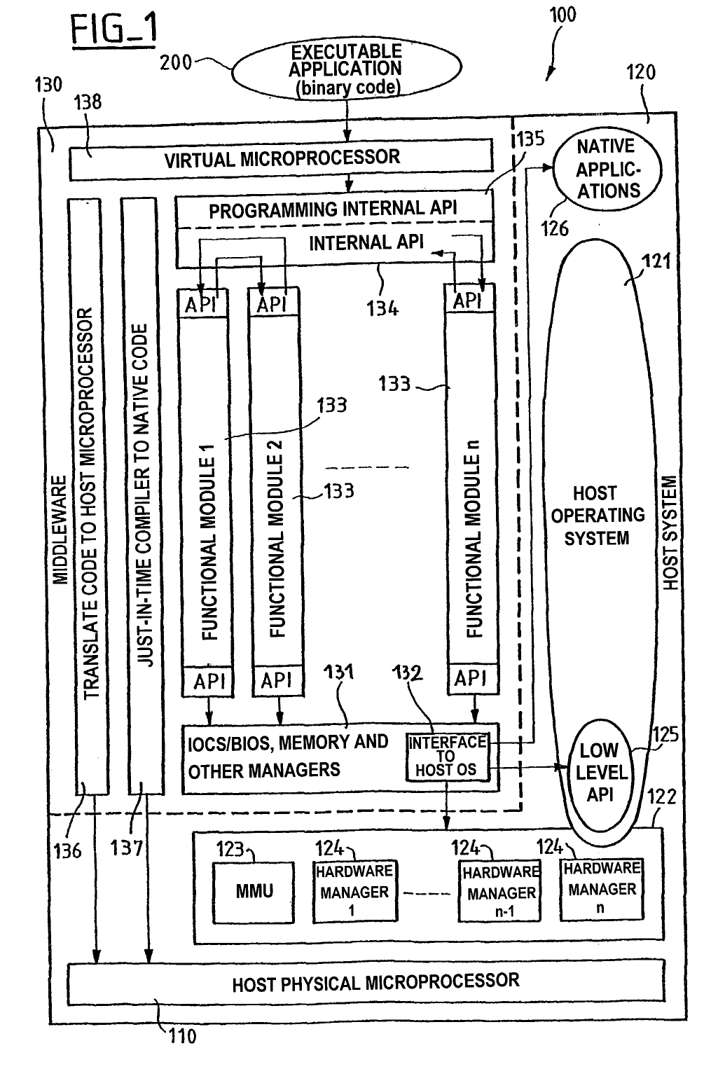

In FIG. 1, reference 100 is an overall reference designating the virtual machine of the invention which operates in response to program instructions from an executable application 200.

The executable application 200 is in a binary code specific to the virtual machine, but the binary code can be obtained from a high level language and it is not linked to one specific language.

Thus, languages such as Java, C, C++, Basic, HTML, WML, etc. can be used, and an application written in one of those languages is processed by means of a development tool comprising an assembler and a compiler (together with a Java bytecode converter, if necessary), in order to produce the executable binary code which is applied directly to the microprocessor of the virtual machine of the invention.

Where appropriate, the development tool can be incorporated in the virtual machine proper, in which case the machine includes, for example, a Java bytecode converter in order to enable a program written in Java to be translated directly into code suitable for execution on the virtual machine.

Furthermore, the language of the virtual machine of the invention is universal in the sense that it is independent of the platform on which it is executed, both in terms of hardware (type of microprocessor) and in terms of software (host operating system).

This “multiple-platform” characteristic is an essential advantage that is provided by the present invention, thus making it possible to develop applications that are reliable, of high performance, and robust on multiple closed platforms or within heterogeneous networks, without being tied to one specific language.

These applications can thus be executed on any platform without it being necessary to know the host operating system or the hardware environment on which it runs, in particular the microprocessor and its input/output peripherals.

In addition, because of the virtual machine structure that is described below, such applications can be executed on machines having limited resources such as personal digital assistants, portable telephones, or indeed TVs, decoders or similar devices, since the virtual machine is designed to consume a strict minimum of power on the local machine both concerning memory (typically less than 64 KB of ROM and 20 Kb of RAM) and concerning microprocessor performance (the virtual machine can accept 8-byte processors with clock speeds of less than 3 MHz).

The virtual machine 100 essentially comprises:

a hardware platform constituted by a physical host microprocessor 110 which may be constituted equally well by a reduced instruction set computer (RISC) or by a complex instruction set computer (CISC);

a host software platform 120 made around a host operating system 121 of an unmodified, pre-existing conventional type; and

middleware 130 co-operating firstly with the hardware and software platforms 110 and 120, and secondly with the application 200 from which it receives executable program instructions in binary code suitable for the virtual microprocessor 138.

The hardware-plus-software platform 110, 120 is a pre-existing platform already integrated into the appliance in question (PDA, telephone, decoder, etc.); it is not modified in any way and it is reused for implementing the virtual machine of the invention, of which it forms an element that is required for operation.

More precisely, the host software platform or host system 120 comprises, in addition to the host operating system 120 proper, a memory management unit (MMU) 123 together with some number of optional hardware managers 124 such as a video manager, a keyboard manager, a multitasking manager, an input manager (mouse, stylus, voice input, etc.).

Together these modules constitute a micro-kernel 122 interfaced with the host operating system 121 by a low level application programming interface (API) 125.

The host platform may also include native applications 126 which are managed in the same way as the host operating system 120.

The host operating system is a known operating system, of which the following can be mentioned for systems that are suitable for mobile and embedded computing: various versions of Windows CE, Epoc 32, Epoc 16, Synergie, PalmOS, various “proprietary” systems such as those of Casio, Texas, Sharp, etc., and also traditional operating systems such as Windows 3.1, 95, 98, NT, or Linux (the names mentioned are trademarks registered by their respective proprietors).

Outside the bold line outlining the virtual machine 100 of the invention (incorporating the elements 110, 120, and 130), all applications devised for the virtual machine of the invention are independent of the platform that is to implement them, both in terms of hardware (microprocessor 110 and associated circuits) and in terms of software (host system 120).

Below and to the right of a boundary dashed line there are all of the pre-existing elements that are reused (hardware and software platforms 110 and 120), while above and to the left of the boundary line there is the middleware 130 of the invention for adapting to different configurations in order to execute an executable application written independently of the platform under consideration.

The middleware 130 is built around a low level layer 131 forming its kernel and containing the low level functions required by the virtual machine of the invention.

This kernel 131 contains an input/output common system and basic input/output system (IOCS/BIOS) together with a memory manager (separate from the memory manager of the host platform) and a stack manager for the middleware 130 and any other managers that it might be advantageous to provide.

More precisely, the kernel 131 must make it possible to run the middleware 130 in independent manner under certain circumstances, for example when managing a peripheral having no host operating system.

To do this, the kernel 130 must make the following possible:

launching of the middleware by the system (call to an input point by the system);

access to the clock, typically with a minimum increment of one second;

allocation of a continuous zone in memory, typically a minimum of 20 Kb of RAM; and

in the presence of an automatic memory-optimizing system, or of a system for allocating memory via a database engine, the option of locking a memory zone of at least 20 Kb.

The kernel 131 does not need an MMU, but it may use an MMU in order to cause a disjoint plurality of different types of physical memory to appear to be contiguous, thus simplifying memory allocation. In all cases, the kernel supplies a continuous program memory zone regardless of whether an MMU is present or absent.

Other functions may optionally be integrated in the kernel 131 for the purpose of supporting it, such as:

allocating and deallocating a memory zone that is shared between a plurality of applications;

an “inter-thread” semaphore, creating and deleting “threads” (for chaining in multitasking operation);

creating and deleting timers;

RAW type reading and writing for a video manager;

keyboard input peripheral (hardware or software keyboard);

a pointer peripheral (stylus, mouse, voice input, etc.), with the possibility of directly accessing the hardware layer or of providing a software emulation based on some other peripheral; for user interaction, input means must be available (serial, infrared, etc. interface);

an output peripheral for a hardware connection (serial, network, infrared, etc. link);

energy saving functions;

optional access to a mass storage system, with the option of providing support for a virtual disk managed in RAM or in flash memory; and

an audible output function if the appliance makes that possible.

The kernel 131 is configured so that only a very small portion of the code represented at 132 (interface with the host operating system) needs to be specific to the host platform; otherwise the kernel is independent of the platform used and can be written in a conventional programming language (e.g. C). The same applies to the remainder of the virtual machine so that in order to port it to a new platform it is necessary only to adapt a very small amount of code, typically about 15 functions, with the remainder of the code being unchanged. It is also possible to integrate specific features for special cases, for example the presence of a plurality of processors in a single appliance or of specific digital signal processors (DSPs), e.g. in the fields of video processing or of telephony.

The interface 132 communicates with the host system and constitutes the necessary point of passage for any exchange of data or calls between the middleware 130 and the host platform. It is this interface which provides communication:

with the host operating system 121 via the low level API 125;

with the native applications 126, if any; and

with the hardware manager and micro-kernel 122 of the host operating system.

In other words, on each call to the host system, whether it involves an operation that is internal to the middleware 130 or executing an instruction of the executable application 200, the call must transit via the interface 132, which is the only portion that is dependent on the host platform.

None of the characteristics provided by the middleware 130 either directly or indirectly makes particular requirements on the host operating system 120. Thus, if a service of the operating system 120 is unavailable or different, a replacement or an addition will automatically be provided by the middleware 130. Furthermore, the middleware, which manages its own stacks and includes its own memory management, does not use the host memory management system if it is not available. The middleware also has an interrupt simulator system if the host system is not capable of providing interrupts.

The integrated graphics management system may provide a graphical user interface (GUI) that is independent of the host operating system so as to implement graphics and windows in more uniform manner, and so as to provide a character font that is constant and identical over all host systems.

Furthermore, the kernel 131 is associated with a series of functional modules 133 with which it communicates via standardized APIs. An internal API 134 provides communication between modules 133, and another API 135 provides an interface for programming.

Each of the modules 133 performs some particular function, which may be the following in particular:

managing a file system (FAT and VFAT);

a database engine;

communications modules;

a TCP/IP stack;

managing a printer;

an electronic book reader and hypertext module;

managing a graphics interface and a graphics module;

tools and a library of various functions; and

interfacing calls to a local system.

The modular structure and independence from the platform make it possible for these various functions to be constantly enriched and improved without requiring any modifications to the architecture or the writing of the remainder of the system. As already mentioned above, only one task is needed to make the virtual machine match a particular host operating system, i.e. it is necessary to port the specific portion 132 as a function of the resources that are available or authorized by the host platform.

Furthermore, the modular structure makes it possible, for example, if necessary or in order to improve execution speed, to use a peripheral driver that is specific to the virtual machine of the invention instead of and replacing the driver of the host system, and this can be done without any need to adapt this particular driver to the platform in question.

In general, this modular structure makes it possible to give the virtual machine of the invention a certain number of functions that are integrated in native manner, independently of the host platform, while conserving the possibility of making practical use of the resources of the host system (if they exist), which continue to operate in parallel to the resources of the middleware.

Conversely, if the host system possesses characteristics which are specific thereto, the virtual machine of the invention can make use of such characteristics instead of those integrated in the middleware, and can do so in a manner that is transparent to applications designed for the virtual machine.

All of the code of the middleware 130 is written in a language independent of the machine, e.g. in the C language, and can advantageously be incorporated in a ROM. Since it is designed to be executed locally, it does not need to be loaded into RAM (unless there are special constraints in the host operating system), thus giving rise to very significant savings in memory requirements and increases in speed.

On being launched, one to five memory zones are allocated, including a zone for the stack belonging to the software 130 and the drivers that manage the peripherals. The startup code also manages the systems for configuring the hardware that it has detected in the corresponding drivers.

The virtual machine of the invention provides an operating environment that is controlled and more reliable than a native system. As a result, the system as a whole, including downloading executable applications or updating the virtual machine, can be executed in the supervisor mode of the system. Operating in supervisor mode only and without it being necessary to use an MMU makes it possible to simplify the virtual machine of the invention and serves to make it more efficient than traditional virtual systems.

Finally, the invention provides means for transcribing the binary code 200 of the virtual machine into low level code that is directly executable on the physical processor 110.

A first means consist in providing a code interpreter 136, more precisely a code translator, generating low level instructions from the binary code and thus identical to a physical microprocessor strategy.

The other means consist in using a just-in-time compiler 137. This means produces an identical result, but processing is performed once only when the application is launched, and not on each instruction. The code thus becomes identical to natively-executable code without it being necessary to interpret it, thus providing a significant increase in speed.

The just-in-time compiler or the code converter are written in a language that is independent of the machine, for example in the C language.

Advantageously, the virtual microprocessor 138 can switch over at any instant and while in operation from an interpreted mode (using the module 136) to a mode that is native to the microprocessor 110, with the switchover instructions that are supplied thereto being integrated in the executable application 200. Under such circumstances, it should be observed that the module 137 (a just-in-time compiler into native code) is neither used nor necessary—it is thus optional (in other words, at least one of the two modules 136 and 137 is needed to implement the system.

1/ A multiple-platform virtual microprocessor (100) and its corresponding operating system, for use in particular for the field of mobile and embedded computing,
characterized in that it comprises in combination:
a host machine with:
a hardware platform (110) comprising a physical host microprocessor; and
a software platform (120) comprising:
a host operating system (121);
memory and hardware manager modules (123 and 124); and
optional native applications (126); and
middleware means (130) comprising:
a kernel (131) implementing low level functions, said kernel including an interface (132) with i) said host operating system, ii) said memory and hardware manager modules, and iii) said native applications, if any;
an API (134, 135) suitable for receiving executable instructions (200) formulated in a language that is independent of the host microprocessor and system, the virtual microprocessor operating in response to said executable instructions;
high level functional modules (133) interfaced i) between one another, ii) with the API, and iii) with the kernel; and
means (136, 137) for transcribing the code of said executable instructions into low level code directly executable on the host microprocessor;
in that all exchange of data between the middleware means (130) and the software platform (120) takes place via said interface (132) of the kernel (131); and
in that all of the middleware means, excepting said interface of the kernel, is encoded in a language independent of the host machine.

2/ The virtual microprocessor and its corresponding operating system of claim 1, in which the code of the middleware is incorporated in a read-only memory or in a microcontroller flash memory.

3/ The virtual microprocessor and its corresponding operating system of claim 1, in which said means for transcribing the executable instruction code into low level code directly executable on the host microprocessor are means taken from the group comprising: a code translator (136); and a just-in-time compiler (137).

4/ The virtual microprocessor and its corresponding operating system of claim 1, in which said means for transcribing the code of the executable instructions into low level code directly executable on the host microprocessor comprise a bytecode converter.

5/ The virtual microprocessor and its corresponding operating system of claim 1, in which said low level functions implemented by the kernel (131) are functions of the group comprising: an IOCS/BIOS; a memory manager distinct from the memory manager of the host platform; and a manager for the stacks of the middleware means.

6/ The virtual microprocessor and its corresponding operating system of claim 5, in which the low level functions implemented by the kernel (131) include managing an integrated graphics user interface that is independent of the host operating system.

7/ The virtual microprocessor and its corresponding operating system of claim 5, in which said low level functions implemented by the kernel (131) further include functions from the group comprising: allocating and deallocating a memory zone shared between a plurality of applications; an inter-thread semaphore; creating and deleting threads; creating and deleting timers; RAW type writing and reading to a video driver; managing a hardware or software keyboard input peripheral; managing a pointer peripheral; managing an output peripheral for a hardware connection; saving energy; giving access to a mass storage system.

8/ The virtual microprocessor and its corresponding operating system of claim 1, in which said high level functional modules (133) are modules suitable for implementing functions of the group comprising: managing a file system; a database engine; communicating with the outside; a TCP/IP stack; managing a printer; reading an electronic book reader; a hypertext module; managing a graphics interface and a graphics module; tools and a library of auxiliary functions; an interface for making a call to a local system.

9/ The virtual microprocessor and its corresponding operating system of claim 1, in which the middleware means are means suitable for being implemented in supervisor mode of the operating system.
